(19) United States
(12) Patent Application Publication
(10) Pub. No.: US 2011/0104017 A1
(43) Pub. Date: May 5, 2011

(54) PORTABLE UV WATER TREATMENT SYSTEM

(76) Inventors: Nicole MIGLIORE, Media, PA (US); Michael MITCHELL, Manalapan, NJ (US); Joanna SWEETGALL, Allendale, NJ (US); Amanda GRIMES, Wilmington, DE (US); Vikki HAZELWOOD, Wayne, NJ (US); Antonio VALDEVIT, Effort, PA (US); Robin STUTMAN, New York, NY (US)

(21) Appl. No.: 12/871,092

(22) Filed: Aug. 30, 2010

Related U.S. Application Data
(60) Provisional application No. 61/242,176, filed on Sep. 14, 2009.

(51) Int. Cl. B01J 19/08

(52) U.S. Cl. 422/186.3

(57) ABSTRACT

A portable water purification system and method of operation of the system is disclosed that may comprise a container defining a water purification chamber; a plurality of UV generating light sources distributed in the purification chamber of the container; and a portable power source electrically connected to the light sources, and adapted to convert kinetic energy to electrical energy to provide to the light sources. The portable power source may be adapted to be driven by human motive power to provide the kinetic energy. The purification system may comprise a filling opening to the container; and a filter intermediate the filling opening and the chamber adapted to remove turbidity from the water entering the water purification chamber through the filling opening. The portable power source may comprise a hand-cranked electrical generator. The UV light sources may produce UV light in a wavelength band selected to effectively deactivate all harmful biological water contaminants, and produce UV light in a dosage sufficient to effectively deactivate all harmful biological water contaminants.

### RELATED CASES

This application claims priority to U.S. Provisional Application Ser. No. 61/242,176, filed on Sep. 14, 2009, entitled PORTABLE UV WATER TREATMENT SYSTEM, the full disclosure of which is hereby incorporated by reference.

### FIELD OF THE INVENTION

The disclosed subject matter relates to a portable water treatment system and, more particularly, to a UV water treatment system that has a portable mechanism for converting kinetic energy to electricity for powering the system.

### BACKGROUND OF THE INVENTION

Currently, devices that utilize UV radiation for the disinfection of water are powered by either AC or DC electrical energy that is provided by fixed electrical sources and/or storage batteries. An individual who uses such a portable water purification device and travels for extended periods of time away from a fixed source of electricity may need to purchase and carry spare batteries, as well as find a place to dispose of used batteries. The user may exhaust the electrical energy stored in the batteries and become stranded without power for water purification.

The main portable water treatment methods used today are: filter devices; UV treatment; boiling and chemical treatment. Filters eliminate the need of battery usage, but have many replaceable parts and are not as effective at eliminating microorganisms as boiling and UV treatment. Boiling has been known for many years as the gold standard for treating water in the wilderness. However, boiling requires large pots and fire, as well as an excessive amount of time for the water to cool down. The SteriPEN® is a currently available portable UV treatment system that uses a battery powered UV rod to swirl into a glass of water, killing bacteria. However, the SteriPEN® system uses an excessive amount of batteries, as it requires one AA battery per three eight ounce glasses of water. Without a proper water bottle to encase the UV light, the SteriPEN® systems also risks UV radiation exposure (e.g., poisoning) to all of its users. It is also only effective if the UV reaches all of the water within the bottle, which is dependent on the user's method for stirring the water with the disinfecting wand.

In order to disinfect water, it is necessary to effectively reduce parasites such as Cryptosporidium parvum and Giardia lamblia, as well as virus, and bacteria contaminant levels. KATADYN® Micropur™ Purification tablets are currently United States Environmental Protection Agency (EPA) registered purification tablets, but the hours of time required to use them effectively may not be completely adhered to by the user in which instance not all contaminants may be completely inactivated. The KATADYN® Micropur™ Bottle and Tablets also do not even claim to eliminate Cryptosporidium, having only been EPA approved for use with Giardia lamblia and bacteria.

Other water purifiers also require additional containers to transfer the water between a storage location and the operating power sources. This adds extra weight and inconvenience for the user.

### SUMMARY OF THE INVENTION

A portable water purification system and method of operation of the system is disclosed that may comprise a container defining a water purification chamber; a plurality of UV generating light sources distributed in the purification chamber of the container; and a portable power source electrically connected to the light sources, and adapted to convert kinetic energy to electrical energy to provide to the light sources. The portable power source may be adapted to be driven by human motive power to provide the kinetic energy. The purification system may comprise a filling opening to the container; and a filter intermediate the filling opening and the chamber adapted to remove turbidity from the water entering the water purification chamber through the filling opening. The portable power source may comprise a hand-cranked electrical generator. The UV light sources may produce UV light in a wavelength band selected to, and in a dosage sufficient to, effectively deactivate all harmful biological water contaminants.

### BRIEF DESCRIPTION OF THE DRAWINGS

For a more complete understanding of the present invention, reference is made to the following detailed description of exemplary embodiments considered in conjunction with the accompanying drawings, in which:

FIG. 1 is a perspective view of a water purification system constructed in accordance with an embodiment of the present invention, a crank generator, by way of example, being shown detached from a water storage/purification unit partly for purposes of clarity;

FIG. 2 is an exploded perspective view of the water purification system shown in FIG. 1;

FIG. 3 is a side view of the water purification system of FIGS. 1 and 2;

FIG. 4 is a cross-sectional view of the water purification system shown in FIGS. 1, 2 and 3, taken along section lines 4-4 of FIG. 3 and looking in the direction of the arrows;

FIG. 5 is a schematic flow chart depicting the steps of a purification process; and

FIG. 6 is a schematic diagram of a circuit diagram of the electronic elements of a water purification device shown in FIGS. 1-4.

### DETAILED DESCRIPTION OF AN EXEMPLARY EMBODIMENT

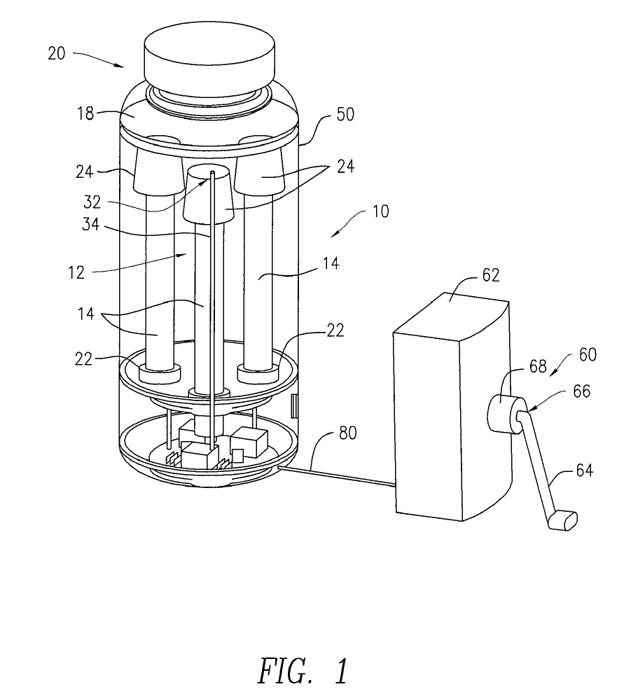

FIGS. 1 through 3 illustrate a water purification system 10 which utilizes germicidal UV (i.e. UV-C) radiation for water sterilization/purification. The system 10 can be used to eliminate or at least deactivate/disinfect biological contaminants, such as viruses, bacteria, and protozoa in the water using UV-C radiation. According to aspects of one embodiment the system 10 can accomplish these tasks by generating electrical power from an accompanying, e.g., integrated, mechanical-electrical generator that is hand powered by the user. The system 10 may include a water storage and treatment/purification container 12.

The system 10 may utilize a plurality of the UV-C bulbs/lamps 14, preferably three, strategically placed at various locations within the bottle/container 12. The use of three UV-C bulbs/lamps 14 is additive and can result in a more powerful user compliant water purification system 10. The system 10 also can incorporate a micro-filter 30, such as is well known for filtering macro-molecules, that can be used to eliminate turbidity of the water to be treated, thus making the UV-C light generated by the bulbs 14 more effective due to increased water clarity.

Everything needed to effectively remove contaminants from the water can be effectively contained within the container 12 of the system 10. Reflective paint on the exteriorly facing sides of UV-C light-bulbs 14 can effectively help to transmit the UV-C waves to be absorbed by any contaminants through the entire interior of the large water storage and treatment/purification container 12, therefore ensuring that all contaminants in the water are reached. The container 12 may be sized to hold, e.g., up to around a liter of water.

The treated water can be poured from the container 12, and consumed directly from the container 12, since a dispensing spout 102 can be made to be retractable into the treatment container 12, to be disinfected between uses by the UV-C light sources 14 within the container 12. Unlike previous so-called portable treatment mechanisms/systems, the system 10 according to aspects of a proposed embodiment can use a unique portable hand-crank mechanism, to provide all of the power needed for the system 10 to function properly. The system 10 can, therefore, be powered completely by mechanical power, eliminating the need to immediately replace parts, such as batteries. The UV-C bulbs/lamps 14 themselves will only need to be replaced after approximately 10,000 uses. This system 10 is scalable to even larger volume treatment/purification containers 12, for systems with even greater treatment capacity.

The system 10 container 12 has, by way of example only, a cylindrical outer casing 50 which defines the water storage/purification bottle/container purification chamber contained within the casing 50, and has a top opening. The water storage bottle 12 may be made from a UV resistant translucent material (e.g., a NALGENE® Labware bottle 12), to maintain the integrity of the bottle 12 and protect the user, or other suitable container (e.g., an injection molded water bottle 12). The UV-C bulbs 14 may be press-fitted into the water storage unit 12, and may be electrically insulated by a plurality of rubber stoppers 24. A cap 20, such as an injection molded cap 20 may seal the filling opening of the water storage unit 12 so that contamination is prevented from entering the unit during storage after treatment. Acylonitrile butadiene styrene (ABS), which is resistant to UV degradation, may be used to fabricate the outer casing 50 of the present invention because it is a rigid polymer that is ideal for applications where resistance, strength, and stiffness are required. It is also lightweight, so it will be able to withstand all the twist and falls of wilderness travel, while being easy to carry around. The cap 20 may be injection molded with ABS or other suitable materials.

The system 10 has a filter 30, such as a metal pre-filter 30 positioned below the container top/cap 20 to remove macro particle contamination from the water, which, as noted, can serve to make the water less turbid to enhance the purification/treatment efficacy of the UV-C light radiated by the UV bulbs 14. The pre-filter 30 can be made of a stainless steel filter element and a black polycarbonate polymer frame element (not shown). The polymer forms an interface between the bottle 12 and the filter 30. The filter 30 can suffice to remove all large scale contaminants to promote the system's compliance to the Safe Drinking Water Guidelines with respect to turbidity levels as outlined by the EPA and at the same time enhance UV-C treatment of the water in the bottle/container 12. The pre-filter 30 may be provided by numerous sources known in the art (e.g., SweetWater® Microfilters).

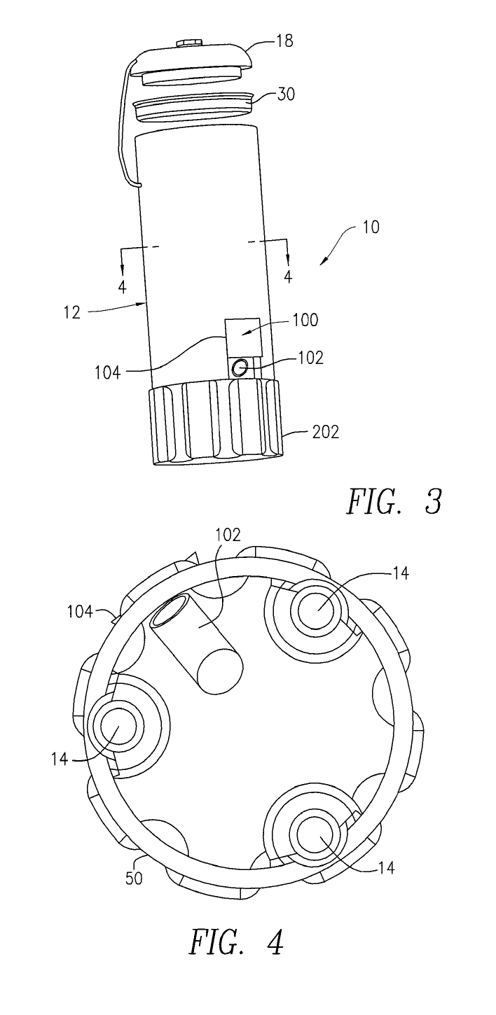

Turning to FIG. 3 there is shown that the water bottle/container component 12 of the system 10 may be injection molded from ABS, the same material as the cap 20, or other suitable materials. The container/bottle 12 may have a lure connection 100 built in to connect to a stock spout component 102. The spout 102 may have a sliding door cover 104, which is a separable component, for the protection and sanitation of the discharge spout. The cover 104 slides open and closed to protect the drinking spout 102 from outside contamination during water collection, and allows for UV-C exposure of the spout 102 during water treatment. The sliding cover 104 may be made from ABS.

The stock spout 102 may include a polypropylene stopcock valve, e.g., with a low-friction plug (not shown) which may be made of Teflon® (TFE). Available stopcock valves can be vacuum-tight, and can resist sticking and freezing. There is no need for lubrication, thereby eliminating the potential for contamination to the user via lubricant. The stopcock valve can be connected to a quick connect tubing connector (not shown) to allow for connection to any of a number of well known accessory drinking straw components (not shown), which may have, for instance, a ¼″ diameter.

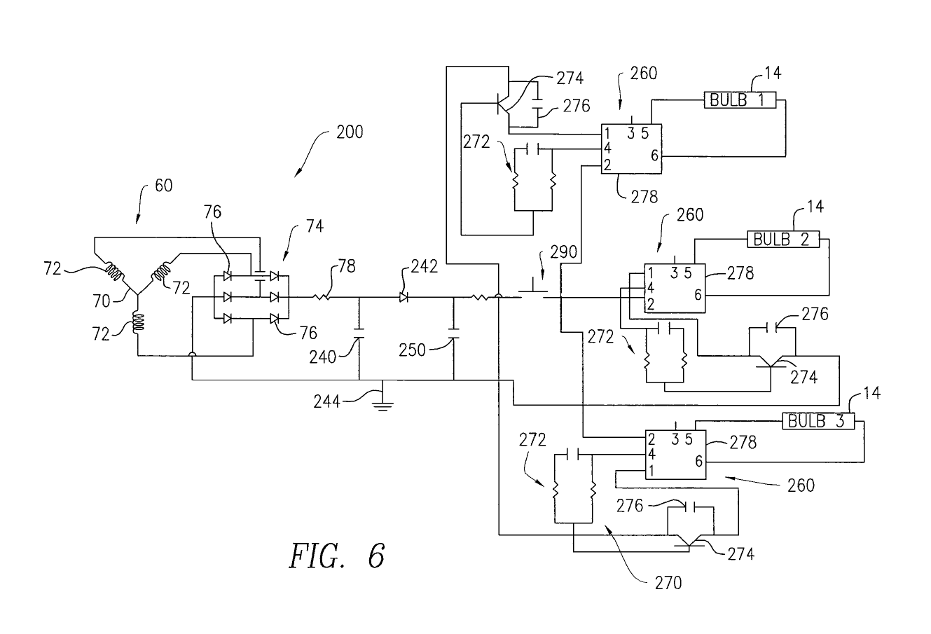

A suitable hand crank mechanical-electrical generator 60 may be provided by a number of sources currently known in the art. The generator 60 may have a generator housing 62 and a hand crank 64 connected to a shaft 66 of a generator rotor 70 (shown schematically in FIG. 6) through a bushing 68. The generator 60 can be selected and configured to generate, as an example, 20 V of DC voltage and up to 2000 ma. When the DC power output is input to a rechargeable lithium battery (not shown), the power so stored in the battery (not shown) can be drained by the plurality of UV-C bulbs 14, which may be electrically arranged in parallel connection to the battery (not shown). Alternately, the DC power may be directly fed to the light sources 14 operating circuitry 200, which may be conveniently housed in an extension 202 of the container 12.

The crank generator 60 may include multiple components. More particularly, a gear box (not shown) may have a spring-loaded crank mechanism (not shown), a magnetic component (not shown) to create electrical charge, and the necessary circuitry 200 to deliver the electrical power generated to the UV-C light sources 14. The components of the generator 60 may be contained in an external casing 62 which may be made of ABS for uniformity of material throughout the system and because ABS is a relatively good insulator and is easy to injection mold. However, the casing 62 may be made from other suitable materials.

The generator 60 may alternatively be positioned in an isolated, insulated cavity within the extension 202 located below the water storage unit container 12. The cavity 202 may also contain electrical components and circuitry 200 that are connected to the generator 60, e.g., through wire 80 and to the light sources 14, e.g., through wires 34, only one of three of which is shown to avoid cluttering the FIG. The crank 64 may serve to wind a spring (not shown), which upon thereafter being released, can deliver enough kinetic energy to propel the generator 60 magnet element (not shown) or windings 70 (shown in FIG. 6) into motion creating the electrical potential that powers the UV-C light sources 14. Alternatively, it will be understood that other forms of rotary motion may be used to store kinetic energy in a spring, or rotation of a rotor, such as rotation of the extension 202 with respect to the container 12, with a spring affixed to either. It will also be understood that the generator 60 may deliver electricity directly to the circuitry 200 to power the UV light sources 14 or to charge a battery(ies) for subsequent or contemporaneous delivery of such battery-provided power to the UV light sources 14.

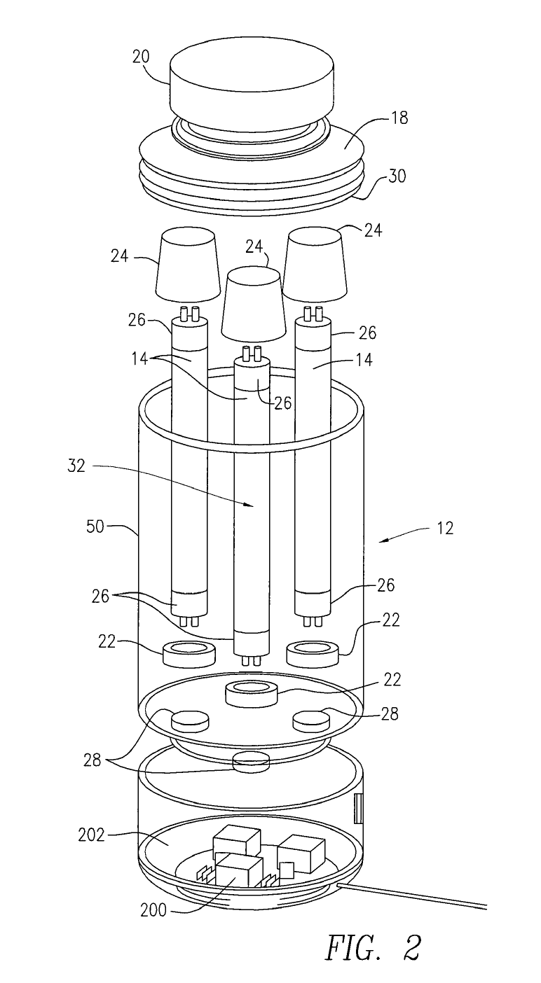

The germicidal UV light sources 14 may be UV-C light bulbs/lamps 14 approximately 5.3 inches tall with a diameter of ⅝ inches, although other sizes and configurations may be utilized. Coverings 24 for electrodes 26 of the UV-C bulbs 14 may be fabricated from polycarbonate, e.g., by injection molding. Only the upper coverings 24 are shown in FIGS. 1 and 2 to avoid clutter up the FIGS. Polycarbonate may be used as the UV-C bulb casing 22 within the water bottle 12 because of polycarbonate's resistance, strength, and stiffness properties, which are traits required in wilderness conditions. Also, polycarbonate can maintain rigidity up to 140 degrees Celsius and toughness down to −20 degrees Celsius. Another useful property that this polymer is that the polymer is clear and colorless, with a high index of refraction, thereby allowing UV-C light to pass through it into the water contained within the container 12, killing all microorganisms. The polymer is also UV-C degradation resistant. The physical properties of the polymer will not be affected by the UV-C radiation.

ABS polymer has been selected as the outer casing 50 material of the system 10 because it is a rigid polymer that is useful for applications where resistance, strength, and stiffness are required. It is also lightweight, so it will be able to withstand all the twists and falls of wilderness travel, while being easy to carry. Also the polymer is a suitable choice due to low cost, a must if the system 10 is to be sold at a reasonable price. ABS, in addition, is easy to machine and fabricate. Such ABS may be obtained such as from The Shanti Plastic Industry.

Ultraviolet wavelengths between 200-290 nm are considered to be in the UVC range, otherwise known as the germicidal range. An optimal germicidal wavelength for elimination of the target types of contamination noted above is approximately 254 nm. There are many classifications of UVC light bulbs/lamps 14, making a differentiation between low and medium pressure mercury arc tubes necessary. Low pressure bulbs 14 are available in ozone producing (fluorescent bulbs) and non-ozone producing (quartz bulbs). Quartz has unique properties which allow the penetration of 254 nm light, while filtering the ozone wavelength, which occurs roughly at 185 nm. In order to maximize the germicidal effectiveness, a non-ozone producing lamp 14 is preferably utilized to irradiate the water with a single wavelength, 254 nm.

The exact wavelengths and intensity ratings for the bulbs 14 may vary, depending upon the manufacturer. It may, therefore, be necessary to test that the intensity of the bulbs 14 actually used in the water purifier 10 meet the specifications suggested by the manufacturer.

As an example low pressure, non-ozone bulbs 14, purchased from Atlantic Light Bulbs, Inc., with a 5.3″ length and ⅝″ diameter were selected. Each bulb 14 requires a power input of 4 watts and has a 2 pin connection 26 at each end, which is adaptable for DC voltage. With an intensity rating of 4000 μW/cm2 up to 6″ away from the bulb 14 and 3 such bulbs 14, the surface area over the length of the canister 12 can be covered sufficiently. The estimated life of these bulbs is 6,000 hrs at a maximum; however the output intensity may sufficiently decay over time to require replacement. For example, it has been estimated that even the highest quality bulbs can drop under 90% of the bulb's maximum intensity rating after only 20% of the bulb's expected life. For the above noted bulbs 14, the bulb 14 could drop from 4000 μW/cm2 to ˜3600 μW/cm2 after 1300 working hours. The suggested service time degradation can be eliminated by choosing UV resistant polymers for construction. Also the bulbs 14 could be replaced after 1,200 hours of use to ensure their efficacy. Higher wattage bulbs 14 may also be selected depending on generator/battery capabilities of driving such bulbs 14. Given a ˜90 second treatment time the bulbs 14 may need to be replaced after 43,000 uses, which, with a reasonable average annual usage, would amount to well over ten years of usage on a single set of bulbs 14.

In order to receive EPA approval for a water purification system 10 according to aspects of an embodiment the turbidity level cannot exceed 5 nephelolometric turbidity units (NTU). In order to ensure that the turbidity level doesn't exceed the specified limit a stainless steel “pre-filter” 30 has been selected. The pre-filtering of the water by the pre-filter 30, as noted above, can also assist in the UV light being most effective. A high turbidity level could “shade” microorganism contaminants, causing them not to absorb the UV and thus not to have the biological contaminants' DNA inactivated.

A stock stainless steel filter 30, e.g., a 75 micron filter 30, available from SweetWater® Microfilters, used as the “Pre Filter” 30 both meets the design requirements for the filter 30 and is cost effective. Made with stainless steel, such a 75-micron pre-filter 30 protects against large particles in water. Stainless steel was chosen because it is not degraded by the UVC light waves. Stainless steel also has a high resistance to heat, corrosion, and rusting due to low carbon content and chromium content.

A polypropylene stopcock 102 with low-friction plug (not shown), made of Teflon® TFE, was chosen as the valve 102 to dispense purified water to the user. The stopcock 102 can be vacuum-tight, yet also be non-stick and non-freeze. No lubricant is needed, and, thus, there is no danger from lubricant contamination. Both ends of the valve 102 may be serrated for receipt of ¼″ to 5/16″ tubing. Polypropylene also can sustain long-term exposure to UV. The Teflon low friction plug (not shown), contained within polypropylene, will not be exposed to UV radiation.

According to aspects of an embodiment of the disclosed subject matter, it will be understood that water treatment/decontamination to eliminate biological contaminants can be done by simply passing the water through the filter 30, closing the lid 20, and cranking the spring loaded mechanism 60. The water can then be purified within about two minutes.

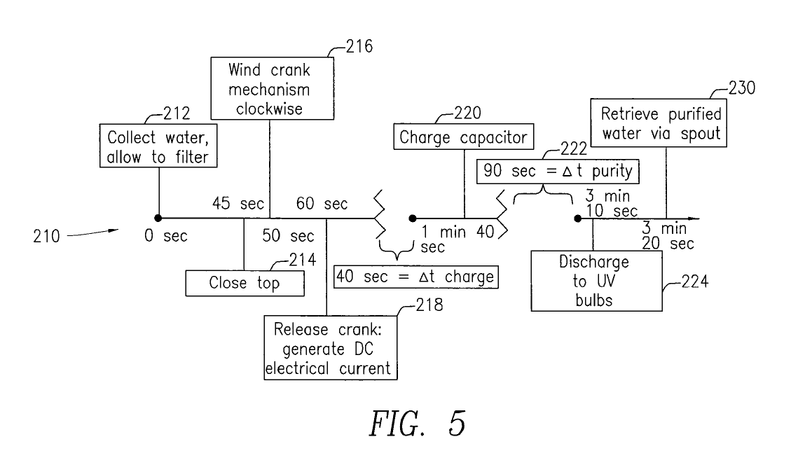

Turning to FIG. 5 there is shown a block diagram of steps in a process 210 occurring while using the system 10 according to aspects of an embodiment of the disclosed subject matter. In the first step in the process 210, represented by block 212, water can be introduced into the container 12 of the water treatment device 10, such as by immersing the device 10 into a pond. The filter 30 is allowed to filter out large particles responsible for both impurity in the water and turbidity of the water. This may take, e.g., about 45 seconds, after which the top 20 may be closed in block 214.

The hand crank may be operated in block 216 to, e.g., provide electrical energy to the circuitry 200 by generator action in response directly to the crank 64 rotary motion turning a generator rotor 70 (shown in FIG. 6), which may take about 10 seconds. Alternatively the turning of the crank 64 may serve to store the kinetic energy produced by turning the crank 64, e.g., in a spring (not shown), which, by way of example, when the crank 64 is released in step 218, can produce the generation of electrical energy. As illustrated in block 220, the electrical energy can charge a capacitor 250 in the circuitry 200 over about a 40 second period as illustrated in FIG. 5. As illustrated in block 222 the capacitor 250 may be discharged through the bulbs 14. This discharge step 224 may last for about ninety seconds and then the purified water can be removed from the container 12 in the step of block 230.

As another example, when the user twists extension 202 in the bottom portion of the container 12 and cranks the spring loaded mechanism (not shown), mechanical energy is being generated. The spring mechanism can be made to stop cranking once it has reached the required amount of rotations to generate the energy required. The crank/spring can then be released, and the mechanical energy generated from the spring causing rotation of a generator rotor 70 will be converted to electrical energy, via the electric generator 60 shown in FIG. 1, or such a generator (not shown) which may be contained in the extension 202. The electric generator 60 converts the kinetic energy to electric energy, e.g., by using electromagnetic induction. Quantitatively, the electromagnetic induction can be expressed as:

$$ɛ = - \frac{d {Φ}_{B}}{d t}$$

Where ε is the electromotive force (EMF) in volts, and ΦB is the magnetic flux through the circuit (in webers). If, for example, an electric conductor such as a winding 70 of copper wire is moved through a magnetic field, electric current will flow in the conductor. As is known in the art magnetic induction generators can be configured to provide AC or DC current output. Thus, the mechanical/kinetic energy of the moving wire is converted into the electric energy of the current that flows in the wire, e.g., of a winging 72 on a rotor 70.

According to aspects of an embodiment of the disclosed subject matter the mechanical energy needed to turn the generator can come from the spring crank mechanism at the front of the generator 60 or other suitable generator, such as one using the crank 64 to rotate the winding 72 through a magnetic field. The hand crank 64 in one embodiment causes the spring (not shown) to store kinetic energy and when released the spring energy causes the rotor 70 (shown in FIG. 6) to spin inside a magnetic field. Movement of the rotor windings 72 through the magnetic field causes electric current to flow in wires contained on the rotor windings 72. The generator 60 provides electric current to wires 80 that lead to a capacitor 250 in the circuitry 200, which will store the electrical energy, e.g., until a desired voltage across the capacitor is reached. Once the amount of energy needed is reached, the capacitor 250 can be discharged through switch 290 and a DC current will flow into the 3 UV bulbs 14, which will be powered to deliver the UV waves needed to purify the water in the container 12.

Turning now to FIG. 6 there is shown schematically a circuit diagram for an exemplary circuit 200 to drive the lamps 14. The circuit 200 may include a rotor 70 on the generator 60, which includes windings 72, which according to one example of a generator 60 useful with embodiments of the disclosed subject matter, may have induced in them alternating current as the windings pass alternately a south pole magnetic element (not shown) and a north pole magnetic element (not shown). The AC output of the generator 60 may be such as 26 Volts peak to peak and approximately 2 amps, which may then be converted to DC voltage in a rectifier 74, which may be a full wave rectifier 74 and consist of 6 diodes 76 and a 100Ω resistor 78 connected to a 100 μF capacitor 240. The full wave rectifier 74 may be a part of the generator electric circuitry in some embodiments. The rectifier 74 may rectify the 26 Volt AC output of the generator 60 to 13 Volts DC supplied in parallel to the capacitor 240, which may be a 1F capacitor 240 and a storage capacitor 250. A diode 242 can assure unidirectional charge to and discharge from the storage capacitor 250.

A switch 290 can be utilized to facilitate simultaneous discharge of the capacitor 250 to the 3 UV-C lamps 14 in parallel through respective charging circuits 260. Closing of the switch 290 provides power to a respective transformer 278, in each charging circuit 260, the secondary windings of each of which transformers 278 are connected across the electrodes 26 of a respective lamp 14. A pulsing portion of the circuit 260 consisting of a respective transistor 274 and a parallel capacitor 276 can create a continuous pulsed switch for current to be supplied to primary windings of the transformer 278 after the switch 290 is closed. The transformer 278, which may be an EE19-4W transformer 278, amplifies voltage and steps current down to supply necessary power for the per bulb 14 requirements noted herein. The transformer 278 may supply 29 volts and 0.170 amps to each UV-C fluorescent lamp 14. An RC circuit 272 for each charging circuit 260 may provide a higher voltage at a lower current to transformer 278 over a selected length of time.

There is a required dosage needed to disinfect the water in the container 12 of all microorganisms, such as in some embodiments 0.0264 Watt seconds (W*s) per square centimeter. Based on the dimensions of an embodiment, the surface area that the UV dosage would have to cover is 3000 square centimeters. The energy required to generate the UV dosage needed to disinfect the amount of water an embodiment of the disclosed subject matter can hold can be determined from the formula:

Energy Required=UV Dosage*Surface Area=(0.0264 W*s/cm²)(3000 cm²)=80 Joules

Energy may be lost in the transfer of energy from the hand crank 64 to the generator components, such as the winding 70, from the generator 60 to the circuitry 200, and from the circuitry 200 to the UV bulbs 14. The UV bulbs themselves may range in efficiency of converting electrical energy to light, from 60-70%. Therefore, it has been estimated that 120 Joules of energy must be supplied by the crank 64 of the crank generator 60, in order to overcome the efficiency issues and provide sufficient power to generate sufficient UV light for a sufficient time needed to disinfect the water in the container 12.

A mechanical crank flashlight from Brookstone Online has been benchmarked to determine the mechanical energy that can be generated from such a crank 64 used to drive such a generator 60. The DC voltage output of the flashlight mechanical crank generator 60 was measured to be 10 Volts (V) at 300 milliamps (mA). The instantaneous maximum power output was calculated using the fundamental equation for power:

P=VI

At 10 V and 300 mA, the power was calculated to be 3 Joules per second (J/s). Therefore, the total time the crank would need to unwind thereby spinning the rotor 70 can be found with the following calculation:

Time to Generate energy=Energy Required/Power Output=120 J/(3 J/S)=40 seconds.

After the amount of rotations needed to coil the spring, the crank can unwind, e.g., for 40 seconds to generate the energy needed to power the UV bulbs to disinfect the water.

In FIG. 6, as noted above, there is described the circuitry 200 that can be used to power three 4 watt UV-C light bulbs from the output of an AC hand crank generator 60. The circuitry 200 can provide the input requirements to power UV-C bulbs 14, such as Phillips G4T5 germicidal UV bulbs 14. Such a bulb 14 requires 29 Volts and 170 ma. For GE 6″ fluorescent utility lights, the voltage is around 6 Volts and current around 600 ma. For 3 such bulbs 14 in parallel, operating at 6.3 Volts the current requirement was found to be 1808.6 ma.

A light fixture for phosphoresced fluorescent bulbs of the same connection and power specifications is also available on the market as is well known. Applicants have verified that such a fixture can power the UV-C G4T5 bulbs purchased, and can be used for the circuitry 200 to power the germicidal lamps 14 in the system 10 according to aspects of an embodiment. The power drawn from a battery pack running the fluorescent light fixtures has been used to determine requirements for the circuit 200. GE 6″ Fluorescent Utility Lights draw approximately 600 milliamps at an operating voltage of approximately 6 volts. The resulting requirements to power the UV lamps were adjusted to those noted above, 6.3 Volta and 1809.6 ma.

The crank generator 60 purchased from Brookstone and extracted from a crank flashlight device was tested. It was found that after rectification from AC to DC voltage, the crank generator 60 would be expected to generate at least 9.4 volts and 2 amps at a frequency of 400 Hz. This would require an electrical efficiency of approximately 67%. If this level of efficiency is desired, the frequency at which the crank is operated and/or the number of turns may be increased to increase the power output. The measured output was 26.7 Volts, 2117.8 ma at a frequency of 401.9 Hz over a period of 2.7 ms. This amounts to full wave rectification voltage of 13.3 Volts and RMS 9.4 Volts.

A maximum UV dosage of 13,000 μWs/cm² was found to be able to be supplied across the container 12 of the device 10, the dosage needed to kill all organisms. The effect of the UV device on bacteria disinfection was measured over time, and proved to kill all traces of E coli within 80 seconds. The device 10 provided a novel means to decontaminate water without the need for any external power, i.e. electricity or batteries, at least not the need to carry replacement batteries. The device 10 can be useful in wilderness applications where external power sources are not accessible, and in third world homes where large-scale water purification systems are not provided by the local government. The system 10 is; efficacious, cost effective, user compliant, and energy efficient.

The apparatus 10 and method of using the apparatus 10 according to the disclosed subject matter overcomes the above-described shortcomings of the art by providing a portable water purification system 10 that utilizes germicidal UV radiation (i.e., UV-C) to disinfect water and is adapted for use by users who travel for extended periods of time away from fixed sources of electricity. More particularly, the system 10 derives its source of electrical energy from an onboard/accompanying portable electrical generator 60 which is adapted for converting kinetic energy provided by human motive force into the needed electricity and power requirements to operate discharge type UV lamps 14. The UV-C emitting elements 14 can then purify the water contained in a purification chamber 12 also containing the lamps 14.

The system 10 is user-friendly and is all-inclusive in that everything that will be needed to effectively remove contaminants from the water will be contained within the system 10. There are fewer parts and/or accessories that the user must bring along with him/her in order for the water purification device 10 to be used effectively. The system is encased in an opaque bottle 12, exposing UV-C to only the water inside without any risk to the user. UV-C light is proven to kill 99.99999% of microorganisms, e.g., within the water in the purification device. Reflective paint on the exteriorly facing sides of the UV-C light-bulbs 14 can effectively help to transmit the UV-C waves in two-dimensional slices that can be absorbed by any contaminants through the entire container/bottle 12, therefore ensuing that all contaminants in the water are reacted/deactivated.

The system 10 utilizes a plurality, preferably three, UV-C light sources, such as bulbs/lamps 14 strategically placed at various locations within the bottle 12. The use of UV-C bulbs 14 is additive and provides a more powerful user compliant water purification system 10.

The system 10 also incorporates a micro-filter 30 that will eliminate turbidity of water to be treated making the UV-C light generated by the bulbs 14 more effective due to increased clarity. Water can be poured from and/or drunk directly from embodiments of the disclosed subject matter because the disposal spout 102 retracts into the treatment bottle 12 and can be disinfected between uses by the UV-C light sources 14 or along with the water in the purification chamber. Unlike other devices, the system 10 uses a unique hand-crank mechanism 60, which provides all of the power needed for the system to function properly. The system 10 is powered completely by mechanical power, created by translating into electrical energy kinetic energy provided by human motive force. This eliminates the need to immediately replace parts, such as dead batteries. UV-C bulbs will only need to be replaced after approximately 10,000 uses. This system may also be adapted to larger scale devices, with larger bulbs 14 and more power required, but still utilizing human motive force, e.g., driving the crank 64 and/or shaft 66 with a bicycle wheel driving mechanism.

It will be understood that the embodiment described herein is merely exemplary and that a person skilled in the art may make many variations and modifications without departing from the spirit and scope of the invention. All such variations and modifications are intended to be included within the scope of the invention.

We claim:

1. A portable water purification system, comprising:
a container defining a water purification chamber;
a plurality of UV generating light sources distributed in the purification chamber of the container; and,
a portable power source electrically connected to the light sources, and adapted to convert kinetic energy to electrical energy to provide to the light sources.

2. The portable water purification system of claim 1 further comprising the portable power source being adapted to be driven by human motive power to provide the kinetic energy.

3. The portable water purification system of claim 1 further comprising:
a filling opening to the container; and,
a filter intermediate the filling opening and the chamber adapted to remove turbidity from the water entering the water purification chamber through the filling opening.

4. The portable water purification system of claim 1 further comprising:
the portable power source comprising a hand-cranked electrical generator.

5. The portable water purification system of claim 1, further comprising:
the UV light sources producing UV light in a wavelength band selected to effectively deactivate all harmful biological water contaminants.

6. The portable water purification system of claim 1 further comprising:
the UV light sources producing UV light in a dosage sufficient to effectively deactivate all harmful biological water contaminants.
